(19) United States
(12) Patent Application Publication
(10) Pub. No.: US 2016/0187559 A1
(43) Pub. Date: Jun. 30, 2016

(54) DISPLAY DEVICE

(71) Applicant: BOE TECHNOLOGY GROUP CO., LTD., Beijing (CN)

(72) Inventor: Wenbo LI, Beijing (CN)

(73) Assignee: BOE TECHNOLOGY GROUP CO., LTD., Beijing (CN)

(21) Appl. No.: 14/891,828

(22) PCT Filed: Jun. 17, 2015
(86) PCT No.: PCT/CN2015/081665

§ 371 Date: Nov. 17, 2015

(30) Foreign Application Priority Data
Dec. 31, 2014 (CN) 201410855883.4

(51) Int. Cl. F21V 8/00

(52) U.S. Cl. CPC G02B 6/009; G02B 6/0021; G02B 6/0031; G02B 6/0065; G02B 6/0085

(57) ABSTRACT

A display device includes: a transparent light guide plate (1) and a light source (3) located at a side of the transparent light guide plate, the light source (3) is arranged to be inclined toward a side of the transparent light guide plate (1) away from its emitting surface (12). A side of the transparent light guide plate (1) facing the light source is an incident slant surface (11) having the same inclined angle as that of the light source (3). The display device can avoid direct radiation of the light generated from the light source upon the array structure zone of the display device, and can achieve a better display effect.

### TECHNICAL FIELD

The embodiment of present invention relates to a kind of display device.

### BACKGROUND

As the living standard of people is increasingly improved, the requirement for the display effect of the display device and its ultrathin appearance is also getting higher and higher.

However, the inventor has found that, in the common display devices, the light source locates at the incident side of the light guide plate, thus since the light source presents a certain emitting angle, the light generated by the light source would directly radiate upon the array structure zone of the display device without passing through the light guide plate, which would influence the display effect of the display device.

### SUMMARY

The embodiment of the present disclosure provides a kind of display device, which may avoid direct radiation of the light generated from the light source upon the array structure zone of the display device, allowing for a better display effect.

The embodiment of the present disclosure provides a kind of display device comprising: a transparent light guide plate and a light source located at a side of the transparent light guide plate, wherein the light source is provided to be angled toward a side of the transparent light guide plate away from its emitting surface; the side of the transparent light guide plate facing the light source has a incident slant surface of the same inclination direction as that of the light source.

For example, the incident slant surface extends from a side of the transparent light guide plate away from its emitting surface to the emitting surface, the light source comprises a light emitter and a lamp shade covering above the light emitter.

For example, the inner side of the lamp shade is provided with a reflective layer.

For example, the side of the transparent light guide plate facing the light source has a V-type groove whose opening faces the light source, the light source is located within the V-type groove, and a side of the V-type groove away from the emitting surface is the incident slant surface.

For example, a side of the V-type groove adjacent to the emitting surface is located at a preset distance from the emitting surface of the transparent light guide plate.

For example, the preset distance is 0.2 mm to 0.5 mm.

For example, the light source comprises a light emitter.

For example, a reflective layer or a blocking layer is provided at the side of the V-type groove adjacent to the emitting surface.

For example, the light source further comprises a lamp shade covering the light emitter, and the lamp shade guides the light from the light emitter to the incident slant surface of the transparent light guide plate.

For example, the inclination angle of the light source is greater than 0° and less than 90°.

For example, the maximum inclination angle of the light source is greater than the total reflection angle of the transparent light guide plate by 10°, and the minimal inclination angle of the light source is less than the total reflection angle of the transparent light guide plate by 10°.

For example, the transparent light guide plate is made of a glass material, and an array structure zone is provided on the emitting surface of the transparent light guide plate.

For example, the emitting surface of the transparent light guide plate are all provided with blocking layers or reflective layers except for the parts corresponding to the array structure zone of the display device.

For example, a reflective layer and/or a black heat transfer layer is provided on the side of the transparent light guide plate away from the light source. For example, the light emitter is a light emitting diode or a cold cathode tube.

For example, the light generated from the light source passes through the transparent light guide plate and then emits from the emitting surface of the transparent light guide plate.

For example, nanoparticles are provided on the side of the transparent light guide plate away from the emitting surface to form a light guide layer.

For example, the reflective layer is a reflective paper, an aluminum layer or a silver layer.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a first partial structural representation of the display device provided by the embodiment of present invention;

FIG. 2 is a second partial structural representation of the display device provided by the embodiment of present invention;

FIG. 3 is a third partial structural representation of the display device provided by the embodiment of present invention;

FIG. 4 is a fourth partial structural representation of the display device provided by the embodiment of present invention;

FIG. 5 is a fifth partial structural representation of the display device provided by the embodiment of present invention.

### REFERENCE NUMERALS

1—transparent light guide plate; 11—incident slant surface; 12—emitting surface; 13—V-type groove; 2—array structure zone; 3—light source; 31—light emitter; 32—lamp shade; 4—blocking layer; 5—reflective layer; 6—black heat transfer layer; 8—vertical plane; h—preset distance.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

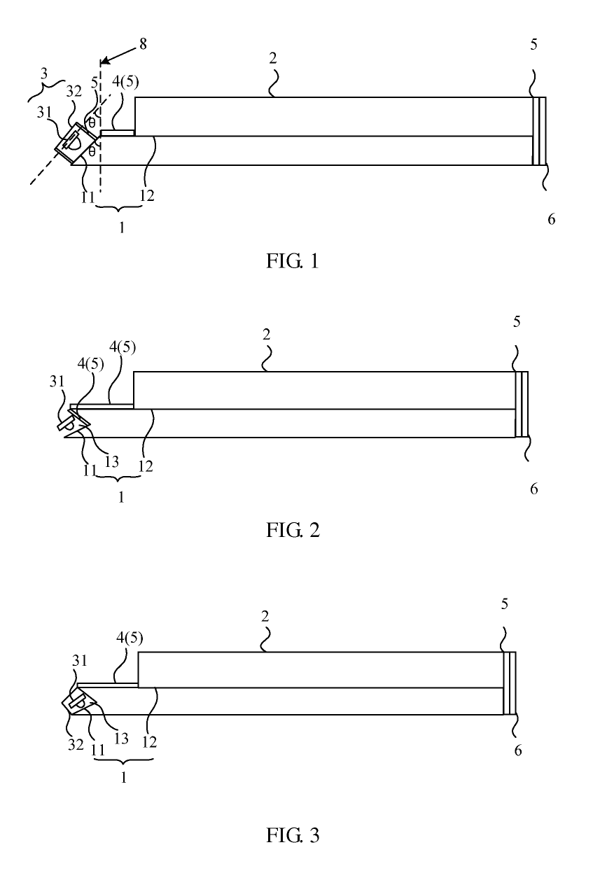

Now turn to FIG. 1, which is a first partial structural representation of the display device provided by the embodiment of present invention. The embodiment of present invention provides a display device comprising: a transparent light guide plate 1 and a light source 3 located at a side of the transparent light guide plate, the light source 3 being arranged to be inclined toward the side of the transparent light guide plate 1 away from its emitting surface 12. That is to say, the light source 3 faces a side of the transparent light guide plate 1 away from its emitting surface 12, and the light source 3 forms an angle with the vertical plane. The side of the transparent light guide plate 1 facing the light source 3 has an incident slant surface 11 of the same inclination direction as that of the light source 3, and the light generated from the light source 3 passes through the transparent light guide plate 1, then emits from the emitting surface 12 of the transparent light guide plate 1.

To be specified, the transparent light guide plate 1 comprises an incident slant surface 11 and an emitting surface 12, the incident slant surface 11 intersects with the emitting surface 12, and the incident slant surface 11 forms an obtuse angle with the emitting surface 12.

The aforesaid inclination direction means such a direction by which the light source deviates from the vertical plane after its placement.

In the display device provided by the embodiment of the present invention, with the light source 3 provided in an inclined way and the incident slant surface 11 provided by the transparent light guide plate 1, the light generated from the light source 3 is irradiated toward the side of the transparent light guide plate 1 away from its emitting surface as much as possible. That is to say, most of the light generated by the light source is caused to enter directly into the transparent light guide plate 1 and then shoots out, it is possible to avoid the light generated from the light source 3 from entering directly into the array structure zone 2 of the display device. Therefore, the display device provided by the embodiment of the present invention presents a better display effect. There are several configurations that may be employed for the display device provided by the embodiment of the present invention. Some of them would be described by may of example in the following.

Configuration One

As shown in FIG. 1, the incident slant surface 11 extends from the side of the transparent light guide plate 1 away from its emitting surface 12 to the emitting surface 12, the incident slant surface 11 forms angle θ with the vertical plane, the light source 3 is provided to be inclined toward the side of the transparent light guide plate 1 away from its emitting surface 12, and the inclination angle is the angle θ. The light source 3 comprises a light emitter 31 and a lamp shade 32 covering above the light emitter 31, the lamp shade 32 guides the light generated by the light emitter 31 toward the incident slant surface 11 of the transparent light guide plate 1. Here due to the fact that the light source 3 is externally provided to the transparent light guide plate 1, in order to prevent the light generated from the inclined light source 3 irradiates directly into the array structure zone 2 of the display device, it is possible to provide a lamp shade 32 covering above the light emitter, the provision of the lamp shade 32 may further prevent the light generated from the light source 3 from entering directly into the array structure zone 2, so that emitting direction of the light source 3 is perpendicular to the incident slant surface 11 as far as possible.

Furthermore, the inner side of the lamp shade 32 is provided with a reflective layer 5. The provision of the reflective layer 5 may improve the utilization ratio of the light source 3 for the display device.

For example, the aforesaid inclination angle θ of the light source 3 is greater than 0° and less than 90°, here the mentioned inclination angle means the angle by which the light source deviates from the vertical plane after its placement. For example, the maximum inclination angle of the light source 3 is greater than the total reflection angle of the transparent light guide plate 1 by 10°, and the minimal inclination angle of the light source 3 is less than the total reflection angle of the transparent light guide plate by 10°.

For example, taking the material for the transparent light guide plate 1 as an example: the refractive index of the glass is 1.5, thus its total reflection angle is 42°, and correspondingly, the maximum inclination angle of the light source 3 may be set to be 52°, and its minimal inclination angle may be set to be 32°, that is, the inclination angle of the light source is in a range of 32° to 52°, for example, 32°, 34°, 36°, 38°, 40°, 42°, 44°, 46°, 48°, 50°, 52°, and the like, repeated description thereof is omitted here. By setting the inclination angle of the light source within the above range, it is possible to further improve the utilization ratio of the light source.

For example, the emitting surface of the transparent light guide plate 1 is provided with an array structure zone thereon. That is to say, on occasions where the transparent light guide plate is made of a glass material, the emitting surface of the transparent light guide plate may be directly manufactured with a layer of film which is patterned so as to form the array structure zone. In this way, a layer of substrate plate may be saved, thus depressing the overall thickness of the display device.

To improve the utilization ratio of the light from the light source for the display device, the emitting surface 12 of the transparent light guide plate are all provided with a blocking layer 4 or a reflective layer 5 except for the parts corresponding to the array structure zone 2 of the display device, the provision of the blocking layer 4 may prevent the occurrence of light leakage of the display device, and the provision of the reflective layer 5 may further improve the utilization ratio of the light source for the display device.

Still farther, for example, a reflective layer 5 and/or a black heat transfer layer 6 is provided on the side of the transparent light guide plate 1 away from the light source 3. The provision of the reflective layer 5 may further improve the utilization ratio of the light, depress the occurrence of light leakage at the side of the display device, and the provision of the black heat transfer layer 6 may depress the influence of heat produced during the operation of the display device upon the array structure zone 2, thus providing a better display effect.

For example, the aforesaid light emitter 31 may be a light emitting diode, and may also be cold cathode tube.

For example, the aforesaid reflective layer may be a reflective paper, and may also be an aluminum layer or a silver layer.

Configuration Two

As shown in FIG. 2, this figure is a second partial structural representation of the display device provided by the embodiment of present invention.

A side of the transparent light guide plate facing the light source 3 has a V-type groove 13 whose opening faces the light source 3, and the light source 3 is located within the V-type groove 13, and a side of the V-type groove 13 away from the emitting surface 12 is the incident slant surface 11. The provision of the V-type groove 13 may accommodate the light source 3 therein, thereby it is possible to reduce the width of the frame of the display device, and also to facilitate packaging of the light source 3 so as to achieve an effect of narrow frame.

For example, the light source 3 used in the display device of such a configuration may only comprise the light emitter 31.

Further, for example, a reflective layer 5 or a blocking layer 4 is provided at the side of the V-type groove 13 adjacent to the emitting surface 12. The provision of the blocking layer 4 may avoid the occurrence of light leakage in the display device. The provision of the reflective layer 5 may further improve the utilization ratio of the light source 3 for the display device.

The aforesaid inclination angle θ of the light source 3 is greater than 0° and less than 90°, here the mentioned inclination angle means the angle by which the light source deviates from the vertical plane after its placement. For example, the maximum inclination angle of the light source 3 is greater than the total reflection angle of the transparent light guide plate 1 by 10°, and the minimal inclination angle of the light source 3 is less than the total reflection angle of the transparent light guide plate by 10°.

For example, taking such a case, in which the material for the transparent light guide plate is glass, as an example. The refractive index of the glass is 1.5, thus its total reflection angle is 42°, and correspondingly, the maximum inclination angle of the light source may be set to be 52°, and its minimal inclination angle is set to be 32°. That is to say, the inclination angle of the light source is in a range between 32° and 52°. This inclination angle is 32 °, 34°, 36°, 38°, 40°, 42°, 44°, 46°, 48°, 50°, 52°, and the like, for example, its repeated description is omitted here. By setting the inclination angle of the light source within the above range, it is possible to further improve the utilization ratio of the light source.

For example, the emitting surface of the transparent light guide plate 1 is provided with an array structure zone thereon. That is to say, on occasions where the transparent light guide plate is made of a glass material, the emitting surface of the transparent light guide plate may be directly manufactured with a layer of film which is patterned so as to form the array structure zone, in this way, it is possible to save one layer of substrate plate, thus reducing the overall thickness of the display device.

For example, to improve the utilization ratio of the light, generated from the light source, for the display device, the emitting surface 12 of the transparent light guide plate 1 is provided with a blocking layer 4 or a reflective layer 5 except for the parts corresponding to the array structure zone 2 of the display device. The provision of the blocking layer 4 may avoid the occurrence of light leakage in the display device. The provision of the reflective layer 5 may further improve the utilization ratio of the light source 3 for the display device.

Still farther, for example, a reflective layer 5 and/or a black heat transfer layer 6 is provided on the side of the transparent light guide plate 1 away from the light source 3. The provision of the reflective layer 5 may further improve the utilization ratio of the light, depressing the occurrence of light leakage at the side of the display device. The provision of a black heat transfer layer 6 may depress the influence of the heat, produced when the display device operates, upon the array structure zone 2, thus allowing for a better display effect.

For example, the aforesaid light emitter 31 may be a light emitting diode, and may also be cold cathode tube.

For example, the aforesaid reflective layer may be a reflective paper, and may also be an aluminum layer or a silver layer.

Configuratio Three

As shown in FIG. 3, this figure is a third partial structural representation of the display device provided by the embodiment of present invention. A side of the transparent light guide plate facing the light source 3 has a V-type groove 13 whose opening faces to the light source 3, and the light source 3 is located within the V-type groove 13, and a side of the V-type groove 13 away from the emitting surface 12 is the incident slant surface 11. The provision of the V-type groove 13 may accommodate the light source 3 therein, thereby it is possible to reduce the width of the frame of the display device, and also to facilitate packaging of the light source 3.

For example, the light source 3 used in the display device of such a configuration may comprise a light emitter 31 and a lamp shade 32 covering above the light emitter 31, the lamp shade 32 guides the light generated by the light emitter 31 toward the incident slant surface 11 of the transparent light guide plate 1. The provision of a lamp shade 32 may cause the light from the light source 3 to irradiate onto the incident slant surface 11 of the transparent light guide plate perpendicularly as far as possible.

For example, the side of the V-type groove 13 adjacent to the emitting surface 12 is provided with a reflective layer 5 or a blocking layer 4 (not shown in the Figs.). The provision of the blocking layer 4 may avoid the occurrence of light leakage in the display device. The provision of the reflective layer 5 may further improve the utilization ratio of the light source 3 for the display device.

The aforesaid inclination angle of the light source 3 is greater than 0° and less than 90°. The inclination angle mentioned here means the angle by which the light source deviates from the vertical plane after its placement. For example, the maximum inclination angle of the light source 3 is greater than the total reflection angle of the transparent light guide plate 1 by 10°, and the minimal inclination angle of the light source 3 is less than the total reflection angle of the transparent light guide plate by 10°. For example, taking the material for the transparent light guide plate 1 as an example: the refractive index of the glass is 1.5, thus its total reflection angle is 42°, and correspondingly, the maximum inclination angle of the light source may be set to be 52°, and its minimal inclination angle may be set to be 32°, that is, the inclination angle of the light source is in a range of 32° to 52°, for example, 32°, 34°, 36°, 38°, 40°, 42°, 44°, 46°, 48°, 50°, 52°, and the like, repeated description thereof is omitted here. By setting the inclination angle of the light source within the above range, it is possible to further improve the utilization ratio of the light source.

For example, the emitting surface of the transparent light guide plate 1 is provided with an array structure zone thereon. That is to say, the transparent light guide plate 1 is made of glass material, when making the array structure zone, the emitting surface of the transparent light guide plate may be directly manufactured with a layer of film which is patterned so as to form the array structure zone. In this way, a layer of substrate plate may be saved, thus depressing the overall thickness of the display device.

For example, to improve the utilization ratio of the light, generated from the light source, for the display device, the emitting surface 12 of the transparent light guide plate 1 is provided with a blocking layer 4 or a reflective layer 5 except for the parts corresponding to the array structure zone 2 of the display device. The provision of the blocking layer 4 may avoid the occurrence of light leakage in the display device. The provision of the reflective layer 5 may further improve the utilization ratio of the light source 3 for the display device.

Still farther, for example, a reflective layer 5 and/or a black heat transfer layer 6 is provided on the side of the transparent light guide plate 1 away from the light source 3. The provision of the reflective layer 5 may further improve the utilization ratio of the light, depressing the occurrence of light leakage at the side of the display device. The provision of a black heat transfer layer 6 may depress the influence of the heat, produced when the display device operates, upon the array structure zone, thus allowing for a better display effect.

For example, the aforesaid light emitter 31 may be a light emitting diode, and may also be cold cathode tube.

For example, the aforesaid reflective layer may be a reflective paper, and may also be an aluminum layer or a silver layer.

Configuration Four

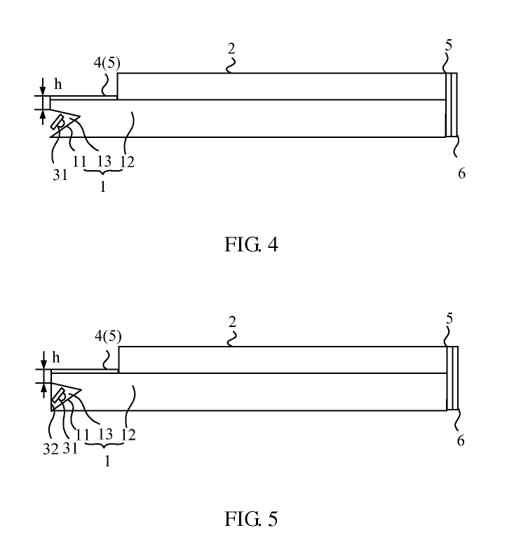

As shown in FIG. 4, this figure is a fourth partial structural representation of the display device provided by the embodiment of present invention. A side of the transparent light guide plate facing the light source 3 has a V-type groove 13 whose opening faces to the light source 3, and the light source 3 is located within the V-type groove 13, and a side of the V-type groove 13 away from the emitting surface 12 is the incident slant surface 11, and a side of the V-type groove 13 adjacent to the emitting surface 12 is located at a preset distance from the emitting surface 12 of the transparent light guide plate 1. That is to say, the transparent light guide plate 1 above the light source has a certain thickness, and with such an arrangement, it is possible to prevent corresponding parts of the transparent light guide plate 1 and the light source 3 from being pressed into breakage.

For example, the preset distance may be 0.2 mm to 0.5 mm.

For example, the light source used in the display device of such a configuration may only comprise the light emitter 31.

For example, the side of the V-type groove 13 adjacent to the emitting surface 12 is provided with a reflective layer 5 or a blocking layer 4 (not shown in the Figs.). The provision of the blocking layer 4 may avoid the occurrence of light leakage in the display device. The provision of the reflective layer 5 may further improve the utilization ratio of the light source 3 for the display device.

The aforesaid inclination angle θ of the light source 3 is greater than 0° and less than 90°, here the mentioned inclination angle means the angle by which the light source deviates from the vertical plane after its placement. For example, the maximum inclination angle of the light source 3 is greater than the total reflection angle of the transparent light guide plate 1 by 10°, and the minimal inclination angle of the light source 3 is less than the total reflection angle of the transparent light guide plate by 10°. For example, taking the material for the transparent light guide plate 1 as an example: the refractive index of the glass is 1.5, thus its total reflection angle is 42°, and correspondingly, the maximum inclination angle of the light source 3 may be set to be 52°, and its minimal inclination angle may be set to be 32°, that is, the inclination angle of the light source is in a range of 32° to 52°, for example, 32°, 34°, 36°, 38°, 40°, 42°, 44°, 46°, 48°, 50°, 52°, and the like, repeated description thereof is omitted here, by setting the inclination angle of the light source within the above range, it is possible to further improve the utilization ratio of the light source.

For example, the emitting surface of the transparent light guide plate 1 is provided with an array structure zone thereon. That is to say, on occasions where the transparent light guide plate is made of glass material, when making the array structure zone, the emitting surface of the transparent light guide plate may be directly manufactured with a layer of film which is patterned so as to form the array structure zone. In this way, a layer of substrate plate may be saved, thus depressing the overall thickness of the display device.

For example, to improve the utilization ratio of the light, generated from the light source, for the display device, the emitting surface 12 of the transparent light guide plate 1 is provided with a blocking layer 4 or a reflective layer 5 except for the parts corresponding to the array structure zone 2 of the display device. The provision of the blocking layer 4 may avoid the occurrence of light leakage in the display device. The provision of the reflective layer 5 may further improve the utilization ratio of the light source 3 for the display device.

Still farther, for example, a reflective layer 5 and/or a black heat transfer layer 6 is provided on the side of the transparent light guide plate 1 away from the light source 3. The provision of the reflective layer 5 may further improve the utilization ratio of the light, depressing the occurrence of light leakage at the side of the display device. The provision of a black heat transfer layer 6 may depress the influence of the heat, produced when the display device operates, upon the array structure zone, thus allowing for a better display effect.

For example, the aforesaid light emitter 31 may be a light emitting diode, and may also be cold cathode tube.

For example, the aforesaid reflective layer may be a reflective paper, and may also be an aluminum layer or a silver layer.

Configuratio Five

As shown in FIG. 5, this figure is a fifth partial structural representation of the display device provided by the embodiment of present invention, a side of the transparent light guide plate facing the light source 3 has a V-type groove 13 whose opening faces to the light source 3, and the light source 3 is located within the V-type groove 13, and a side of the V-type groove 13 away from the emitting surface 12 is the incident slant surface 11, and a side of the V-type groove 13 adjacent to the emitting surface 12 is located at a preset distance h from the emitting surface 12 of the transparent light guide plate 1. That is to say, the transparent light guide plate 1 above the light source has a certain thickness; it is possible to prevent corresponding parts of the transparent light guide plate 1 and the light source 3 from being pressed into breakage.

For example, the preset distance may be 0.2 mm to 0.5 mm.

For example, the light source 3 used in the display device of such a configuration may comprise a light emitter 31 and a lamp shade 32 covering above the light emitter 31, the lamp shade 32 guides the light generated by the light emitter 31 toward the incident slant surface 11 of the transparent light guide plate 1. The provision of a lamp shade 32 may cause the light from the light source 3 to irradiate onto the incident slant surface 11 of the transparent light guide plate perpendicularly as far as possible.

For example, the side of the V-type groove 13 adjacent to the emitting surface 12 is provided with a reflective layer 5 or a blocking layer 4 (not shown in the Figs.). The provision of the blocking layer 4 may avoid the occurrence of light leakage in the display device. The provision of the reflective layer 5 may further improve the utilization ratio of the light source 3 for the display device.

The aforesaid inclination angle θ of the light source 3 is greater than 0° and less than 90°, here the mentioned inclination angle means the angle by which the light source deviates from the vertical plane after its placement. For example, the maximum inclination angle of the light source 3 is greater than the total reflection angle of the transparent light guide plate 1 by 10°, and the minimal inclination angle of the light source 3 is less than the total reflection angle of the transparent light guide plate by 10°. For example, taking the material for the transparent light guide plate 1 as an example: the refractive index of the glass is 1.5, thus its total reflection angle is 42°, and correspondingly, the maximum inclination angle of the light source may be set to be 52°, and its minimal inclination angle may be set to be 32°, that is, the inclination angle of the light source is in a range of 32° to 52°, for example, 32°, 34°, 36°, 38°, 40°, 42°, 44°, 46°, 48°, 50°, 52°, and the like, repeated description thereof is omitted here. By setting the inclination angle of the light source within the above range, it is possible to further improve the utilization ratio of the light source.

For example, the emitting surface of the transparent light guide plate 1 is provided with an array structure zone thereon. That is to say, on occasions where the transparent light guide plate is made of glass material, when making the array structure zone, the emitting surface of the transparent light guide plate may be directly manufactured with a layer of film which is patterned so as to form the array structure zone, in this way, it is possible to save one layer of substrate plate, thus reducing the overall thickness of the display device.

For example, to improve the utilization ratio of the light, generated from the light source, for the display device, the emitting surface 12 of the transparent light guide plate 1 is provided with a blocking layer 4 or a reflective layer 5 except for the part corresponding to the array structure zone 2 of the display device. The provision of the blocking layer 4 may avoid the occurrence of light leakage in the display device. The provision of the reflective layer 5 may further improve the utilization ratio of the light source 3 for the display device.

Still farther, for example, a reflective layer 5 and/or a black heat transfer layer 6 is provided on the side of the transparent light guide plate 1 away from the light source 3. The provision of the reflective layer 5 may further improve the utilization ratio of the light, depressing the occurrence of light leakage at the side of the display device. The provision of a black heat transfer layer 6 may depress the influence of the heat, produced when the display device operates, upon the array structure zone, thus allowing for a better display effect.

For example, the aforesaid light emitter 31 may be a light emitting diode, and may also be cold cathode tube.

For example, the aforesaid reflective layer may be a reflective paper, and may also be an aluminum layer or a silver layer.

Of course, the display device provided in the embodiment of the present invention is not limited to the above several configurations, that is to say, the configuration of the transparent light guide plate is also not limited to the ones listed above. The material for the transparent light guide plate is also not restricted, for example, it may be glass material or resin material etc.

Further, for example, the first substrate or second substrate in the display panel of the display device constitutes the aforesaid transparent light guide plate, that is to say, the aforesaid transparent light guide plate is integrated onto the first substrate or the second substrate of the display panel, here taking a case, in which the transparent light guide plate is integrated onto the second substrate, as an example, the display device mainly comprises: a first substrate and a second substrate arranged oppositely to each other, and a crystal molecule layer located between the first substrate and the second substrate, a side of the first substrate facing the crystal molecule layer is manufactured with a color filter layer, and a side of the second substrate facing the crystal molecule layer is manufactured with an array structure zone, while a side of the second substrate away from the crystal molecule layer (away from a side of the emitting surface) is manufactured with nanoparticles so as to form a light guide layer, and a side of the light guide layer away from the crystal molecule layer is manufactured with a reflector plate, a side of the second substrate is attached with a light source, which light source is generally placed so as to form a certain angle with the vertical plane (in an inclination arrangement). The light source is arranged to be inclined toward a side of the second substrate (the transparent light guide plate) away from its emitting surface in the display device of aforesaid configuration, the transparent light guide plate is integrated with the second substrate (the original second substrate and transparent light guide plate are replaced with one glass substrate, and the thickness of the original second substrate and transparent light guide plate thus becomes the thickness of one piece of glass substrate). That is to say, the second substrate per se owns the function of a light guide plate. In aforesaid display device, the light source is closer to the array structure zone of the display device, to depress the influence of the light from the light source upon the array structure zone, thereby, such a display device may use the configuration of any one of aforesaid configuration one to configuration five. That is to say, the configuration of the transparent light guide plate mentioned in configurations one to five is the configuration of the second substrate in the display device of above configurations, thereby it is possible to depress the influence of the light source upon the array structure zone and improve the display effect of the display device.

For example, the display device may be a liquid crystal panel, an electronic paper, a cellphone, a watch, a tablet computer, a television, a display, a notebook computer, a digital photo frame, a navigator and any products or parts having display functions.

To be specified, in the embodiment of the present invention, the patterning process may only comprise a photolithographic process, or comprise a photolithographic process and an etching step, and at the same time, may further comprise other processes for forming predetermined patterns, such as printing, inkjeting and the like. Here the photolithographic process means a process which comprises film formation process, exposure process, development process and the like while forming patterns with photoresist, mask plates, exposure machine etc. The patterning process may be selected depending on the configuration formed in the embodiment of the present invention.

The above are only specific embodiments of the present invention, the protective scope of the present invention is not restricted thereto, and any skilled person in this art may readily conceive alteration or modification within the technical scope disclosed in the present invention, all of which are encompassed within the protective scope of the present invention. Therefore, the protective scope of the present invention should be construed in accordance with the protective scope of the claims.

The present application claims the priority of the Chinese patent application No. 201410855883.4 filed on Dec. 31, 2014, the entirety of which is incorporated herein by reference as a part of the present application.

1. A display device comprising a transparent light guide plate and a light source located at a side of the transparent light guide plate,
wherein the light source is provided to be inclined toward a side of the transparent light guide plate away from its emitting surface; and a side of the transparent light guide plate facing the light source is an incident slant surface having a same inclined angle as that of the light source.

2. The display device according to claim 1, wherein the incident slant surface extends from the side of the transparent light guide plate away from its emitting surface to the emitting surface, the light source comprises a light emitter and a lamp shade covering the light emitter, and the lamp shade guides the light from the light emitter to the incident slant surface of the transparent light guide plate.

3. The display device according to claim 2, wherein a reflective layer is provided on an inner side of the lamp shade.

4. The display device according to claim 1, wherein the side of the transparent light guide plate facing the light source has a V-type groove whose opening faces the light source, the light source is located within the V-type groove, and a side of the V-type groove away from the emitting surface is the incident slant surface.

5. The display device according to claim 4, wherein a side of the V-type groove adjacent to the emitting surface is located at a preset distance from the emitting surface of the transparent light guide plate.

6. The display device according to claim 5, wherein the preset distance is 0.2 mm to 0.5 mm.

7. The display device according to claim 4, wherein the light source comprises a light emitter.

8. The display device according to claim 7, wherein a reflective layer or a blocking layer is provided at the side of the V-type groove adjacent to the emitting surface.

9. The display device according to claim 7, wherein the light source further comprises a lamp shade covering the light emitter and the lamp shade guides the light from the light emitter to the incident slant surface of the transparent light guide plate.

10. The display device according to claim 1, wherein the inclination angle of the light source is greater than 0° and less than 90°.

11. The display device according to claim 10, wherein a maximum inclination angle of the light source is greater than a total reflection angle of the transparent light guide plate by 10°, and a minimal inclination angle of the light source is less than the total reflection angle of the transparent light guide plate by 10°.

12. The display device according to claim 1, wherein the transparent light guide plate is made of a glass material and an array structure zone is provided on the emitting surface of the transparent light guide plate.

13. The display device according to claim 12, wherein the emitting surface of the transparent light guide plate is provided with a blocking layer or a reflective layer except for a part corresponding to the array structure zone of the display device.

14. The display device according to claim 13, wherein a reflective layer and/or a black heat transfer layer is provided on the side of the transparent light guide plate away from the light source.

15. The display device according to claim 13, wherein the light emitter is a light emitting diode or a cold cathode tube.

16. The display device according to claim 1, wherein the light from the light source passes through the transparent light guide plate and then emits from the emitting surface of the transparent light guide plate.

17. The display device according to claim 1, wherein nanoparticles are provided on a side of the transparent light guide plate away from the emitting surface to form a light guide layer.

18. The display device according to claim 2, wherein the reflective layer is a reflective paper, an aluminum layer or a silver layer.

19. The display device according to claim 2, wherein the light from the light source passes through the transparent light guide plate and then emits from the emitting surface of the transparent light guide plate.

20. The display device according to claim 2, wherein nanoparticles are provided on a side of the transparent light guide plate away from the emitting surface to form a light guide layer.
